(19) United States
(12) Patent Application Publication
(10) Pub. No.: US 2010/0172130 A1
(43) Pub. Date: Jul. 8, 2010

(54) ATMOSPHERE LIGHT

(76) Inventor: Te-Hsuan HSIEH, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/350,948

(22) Filed: Jan. 8, 2009

(51) Int. Cl. F21V 9/00; F21V 21/00

(52) U.S. Cl. 362/231; 362/249.01; 362/249.02

(57) ABSTRACT

An atmosphere light having a light post with carved character or patterns comprises a first light source, a second light source, a light post, and a light holder. The light post is mounted on the light holder, and the second light source is disposed at an appropriate position on the light post to project light outward. The light post is at least partially or fully made of light-transmitting material, and a surface of which is carved with characters or patterns. The first light source is disposed on the surface of the light holder and projects colorful light outward through the light-transmitting material, and the projection of the patterns created by a color light source projecting light through the light-transmitting light post can create desired atmosphere.

### BACKGROUND OF THE INVENTION

1. Field of the Invention

The present invention relates to a light, and more particularly to a light, the inner or outer surface of the light post of which is carved with character or patterns, and the projection of the patterns created by a color light source projecting light through the light-transmitting light post can create desired atmosphere.

2. Description of the Prior Art

Modern people are fastidious about the quality of life, many of them are good at decorating their own living spaces by making use of various kinds of lights. In addition to illumination, the more import is to create atmosphere.

Lights normally include table light, ceiling light, floor light and etc. To add the light variation and create the atmosphere, most of the lights are covered with a light shade which can be changed in many respects, such as color, shape and pattern. On top of that, some of the lights also provide options in configuration, for example, the light post can be folded into desired shapes.

In addition to supporting the light and providing basic changes in shape, how to further provide the light post with new ideas is the direction that the field is working toward.

### SUMMARY OF THE INVENTION

The primary object of the present invention is to provide an atmosphere light which is capable of creating desired atmosphere by projecting colorful light rays through a light-transmitting light post.

To achieve the above object, an atmosphere light provided by the present invention comprises: a first light source, a second light source, a light post, and a light holder. The light post is mounted on the light holder, and the second light source is disposed at an appropriate position on the light post to project light outward. The light post is at least partially or fully made of light-transmitting material, and a surface of which is carved with characters or patterns. The first light source is disposed on the surface of the light holder and projects colorful light outward through the light-transmitting material.

### BRIEF DESCRIPTION OF THE DRAWINGS

FIG. 1 is a perspective view of an atmosphere light in accordance with a first embodiment of the present invention;

FIG. 1A is an operational view of FIG. 1;

FIG. 2 is a perspective view of an atmosphere light in accordance with a second embodiment of the present invention;

FIG. 2A is an operational view of FIG. 2;

FIG. 3 is a perspective view of an atmosphere light in accordance with a third embodiment of the present invention;

FIG. 3A is an operational view of FIG. 3;

FIG. 4 is a perspective view of an atmosphere light in accordance with a fourth embodiment of the present invention; and

FIG. 4A is an operational view of FIG. 4.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

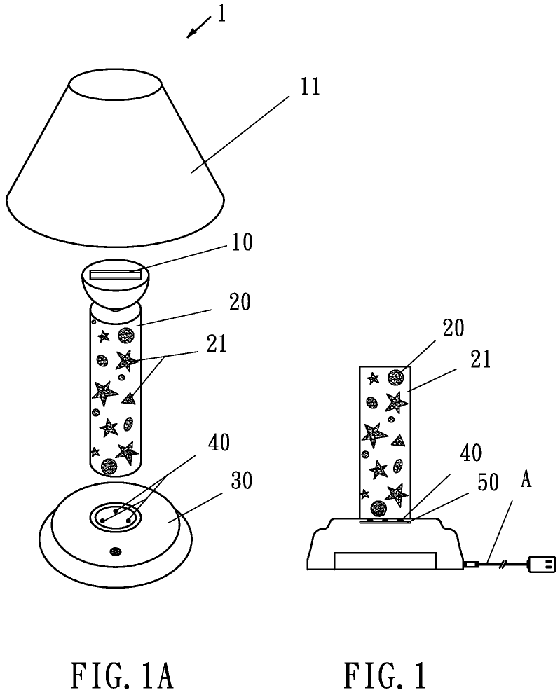

Referring to FIGS. 1 and 1A, a light 1 in accordance with the present invention comprises: a second light source 10, a light post 20, a light holder 30, and a first light source 40. The light post 20 is mounted on the light holder 30 which is connected to a power supplying device A (which refers to an AC to DC converter plug), and the second light source 10 (which can be incandescent light or single-packaged high power light emitting diode LED) is disposed on the top of the light post 20 and used to project light upward. The second light source 10 is provided with a light shade 11 so as to add visual effects and light projecting directions.

The light post 20 is at least partially or fully made of light-transmitting material, the surface of which is carved with (or by any means) characters or patterns as shown in the drawing, such as stellated, circular, triangular patterns 21. The first light source 40 is disposed on the surface of the light holder 30 to project light toward the above light-transmitting light post 20 and is capable of providing 16 million color combinations of light under the control of a control circuit 50 inside the light holder 30.

The patterns 21 on the surface of the light post 20 are composed of a plurality of concave or convex circular dots (or can be stripped or irregularly shaped units) or can be formed by carving a plurality of continuous or intermittent lines. The light projecting direction of the first light source 40 is upward, and the first light source 40 includes plural light units which are disposed in a central concave portion of the light holder 30 in a spaced-apart relation, such arrangement ensures that the light from the first light source 40 can be projected toward the above light-transmitting light post 20, and further, it can prevent the wires of the first light source 40 from being exposed out of the light post 20, which otherwise will affect the projection effect of the first light source 40 and the spoil the appearance of the light post 20.

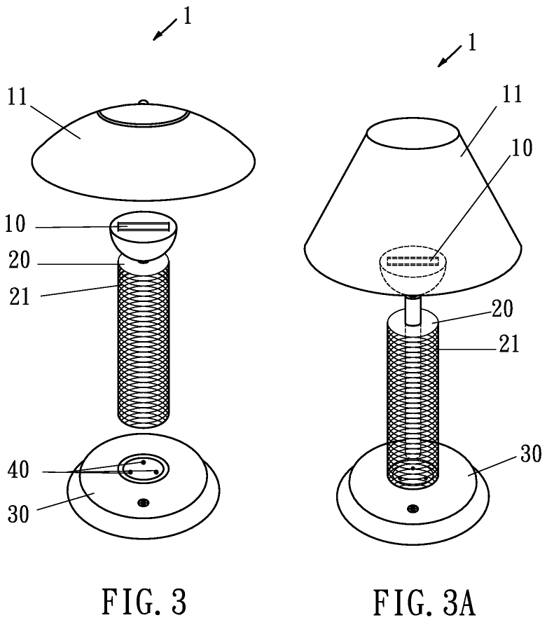

With the first light source 40, the projection of the characteristic or patterns 21 can produce different visual effects, as shown in FIG. 3, when the first light source 40 projects light onto the light-transmitting post, the concave and convex structures of the light-transmitting post will produce different refraction effects, making the light rays focus or diffuse, and then the patterns 21 are projected into the room where the light is located, creating a desired atmosphere.

In the present invention, the light 1 can be floor light, standing light, table light, bedside light, wall light, ceiling light or the likes. The first light source 40 is optimally of LED type, or can be the LEDs capable of independently producing three primary color light rays, the red, green and blue, and the first light source 40 is controlled by the control circuit 50 which serves to adjust the color and light intensity proportion of the LEDs, so as to create colorful projection of the patterns according to user•s requirements.

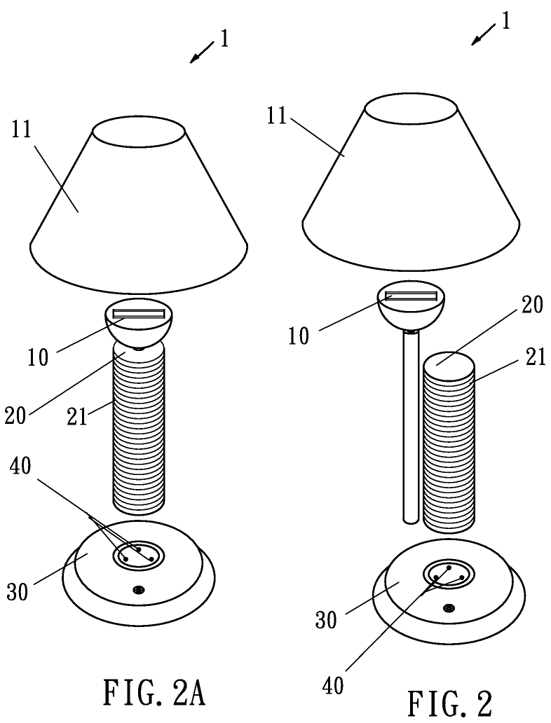

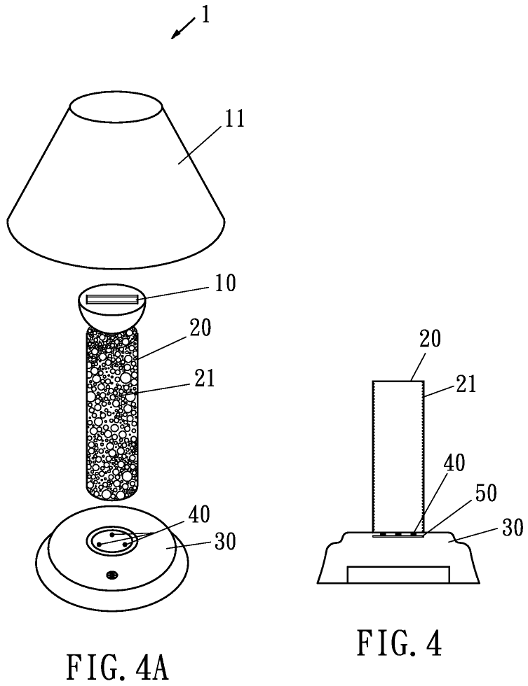

In addition, as shown in FIGS. 2 and 2A, the patterns can be processed by CNC (computer numerical control) machine to form plural annular marks at relatively large intervals. As shown in FIGS. 3 and 3A, the patterns can also be plural annular marks with relatively small intervals and formed by laser carving means. Or as shown FIGS. 4 and 4A, the patterns can also be formed by special methods (such as cutting, or sand blasting) to form scars or frost on the surface of the light post 20. All these methods can create different visual effects and atmosphere to further satisfy the requirements of different users.

To sum up, in addition to the supporting function, the light post of the present invention can be also used to create desired atmosphere through the projection of its carved patterns by the first colorful light source.

While we have shown and described various embodiments in accordance with the present invention, it is clear to those skilled in the art that further embodiments may be made without departing from the scope of the present invention.

What is claimed is:

1. An atmosphere light comprising: a light post and a light holder, the light post being mounted on the light holder;
wherein the light post is at least partially made of light-transmitting material, a surface of which is carved with characters or patterns, the light further comprises a first light source which projects light outward through the patterns of the light-transmitting material.

2. The atmosphere light as claimed in claim 1, wherein the first light source is disposed on a surface of the light holder.

3. The atmosphere light as claimed in claim 1, wherein the first light source is LED type light source.

4. The atmosphere light as claimed in claim 1, wherein the first light source comprises three types light emitting diodes which are capable of producing red, green and blue light rays, and the first light source is controlled by a control circuit which serves to adjust color and light intensity proportion of the light emitting diodes.

5. The atmosphere light as claimed in claim 2, wherein the first light source comprises three types light emitting diodes which are capable of producing red, green and blue light rays, and the first light source is controlled by a control circuit which serves to adjust color and light intensity proportion of the light emitting diodes.

6. The atmosphere light as claimed in claim 3, wherein the first light source comprises three types light emitting diodes which are capable of producing red, green and blue light rays, and the first light source is controlled by a control circuit which serves to adjust color and light intensity proportion of the light emitting diodes.

7. The atmosphere light as claimed in claim 1, wherein the patterns on the light post are composed of concave or convex circular dots, stripped or irregularly shaped units.

8. The atmosphere light as claimed in claim 1, wherein the patterns are formed of continuous or intermittent lines.

9. The atmosphere light as claimed in claim 1 further comprising a second light source which is located at an appropriate position on the light post to project light outward.

10. The atmosphere light as claimed in claim 2 further comprising a second light source which is located at an appropriate position on the light post to project light outward.

11. The atmosphere light as claimed in claim 3 further comprising a second light source which is located at an appropriate position on the light post to project light outward.

12. The atmosphere light as claimed in claim 4 further comprises a second light source which is located at an appropriate position on the light post to project light outward.

13. The atmosphere light as claimed in claim 5 further comprises a second light source which is located at an appropriate position on the light post to project light outward.

14. The atmosphere light as claimed in claim 6 further comprises a second light source which is located at an appropriate position on the light post to project light outward.

15. The atmosphere light as claimed in claim 1, wherein the patterns are formed by computer numerical control machine.

16. The atmosphere light as claimed in claim 1, wherein the patterns are scars formed by cutting method.

17. The atmosphere light as claimed in claim 1, wherein the patterns are formed by laser carving means.

18. The atmosphere light as claimed in claim 1, wherein the patterns are formed by sand blasting.
